(19) United States
(12) Patent Application Publication
(10) Pub. No.: US 2004/0029284 A1
(43) Pub. Date: Feb. 12, 2004

(54) Method for preparing organic or inorganic samples for clinical or scientific examination and machine for implementing said method

(76) Inventors: Ursula Hess, Solothurn (CH); Francisco Ruiz Robles, Tarragona (ES)

Correspondence Address: DENNISON, SCHULTZ & DOUGHERTY, 1745 JEFFERSON DAVIS HIGHWAY, ARLINGTON, VA, 22202, US

(21) Appl. No.: 10/333,917

(22) PCT Filed: Jul. 27, 2001
(86) PCT No.: PCT/ES01/00302

(30) Foreign Application Priority Data
Aug. 4, 2000 (ES) P200002111

(51) Int. Cl. B05C 3/00; G01N 1/00

(52) U.S. Cl. 436/43; 118/423; 436/174

(57) ABSTRACT

Procedure for the preparation of organic tissue samples for the further examination and clinic or scientific study thereof and the corresponding machine of the type having a plurality of circularly arranged beakers (3) turntable containing different processing liquid compositions (2) and a basket (1) containing the samples, consisting said procedure in the addition of the agitation phase of the stratified composition of the processing liquid, which is performed through a clockwise self-rotating rotary movement of the basket (1) immediately followed by a further movement in the opposite direction; the gravity draining phase is replaced by the centrifugal phase and the further optional translation thereof to eventually be received in the next beaker carrying a different composition.

The object of the present Patent of Invention is to provide a procedure for the preparation of organic or inorganic samples for the clinic or scientific examination thereof and machine for performing the said procedure.

Heretofore procedures for the preparation of samples such as, organic tissues for the further clinic examination and study thereof, have proved to have different shortcomings that hinder obtaining optimal quality preparations for doctors to perform the examination and study thereof.

One of above mentioned shortcomings is the fact that the reactive liquids received within the beakers wherein organic tissue samples are immersed become contaminated with the substances coming from the processed samples (for instance, from the water in the dehydratation processes of the sample) and as a result they form superposed stratified layers and thus the organic matter sample that is being processed may not be uniformly processed by the reactive liquid.

In order to avoid this disadvantage manufacturers of this sector have been forced to include in the process a phase of up and down movements of the basket within the reactive liquid.

However, although with the above additional phase a better impregnation of the organic tissue samples is obtained, contact with the liquid is still precarious for the liquid is still not wholly mixed in an uniform way.

A further problem found in known procedures and machines is the fact that as the different beakers containing reactive liquids therein are arranged on a circular or lineal turntable, whereon the organic tissue sample undergoes successive processes with different reactive liquids, the basket is suspended for a predetermined time interval above basket is suspended for a predetermined time interval above the level of liquid contained within the beaker wherein it has been immersed in order to obtain gravity drainage of the liquid remaining in the basket or baskets. This time interval is substantially long for the gravity drainage to be effective and thus keeping the reactive liquid from the previous phase beaker from flowing into the beaker of the following phase while the immersion thereof is occurring.

Naturally, the above drainage time interval is essential for the treatment process of the organic matter until the completion thereof, taking into consideration that the process is performed in successively arranged stations. The sum of each and every phase of sample drainage in each station represents a considerable waste of time.

Further, the result obtained is not a thorough drainage for in practice there always remains some extra liquid. This results in the contamination of the reagents caused by the mixture thereof with reagents from other beakers, which reduces the effective life thereof and hence it makes the process more costly.

Also, account is to be taken of the fact that it is difficult to control the drainage time interval needed in each station, since it will depend upon the physical characteristics of the liquid to be drained, for instance its density, viscosity, etc. This increases reagent contamination and drainage time intervals.

The object of this invention has been developed in order to avoid all the above disadvantages. It enables achieving an optimal final result as far as the processing of organic matter is concerned as well as a major reduction of the overall time interval for the basket or baskets drainage phase and, consequently, for the organic matter introduced therein. Furthermore, reagent contamination is substantially reduced which results in a less costly process.

For an appropriate interpretation, below is described an embodiment by way of an non-limiting example of the present invention and the accompanying 6 sheets of drawings in which:

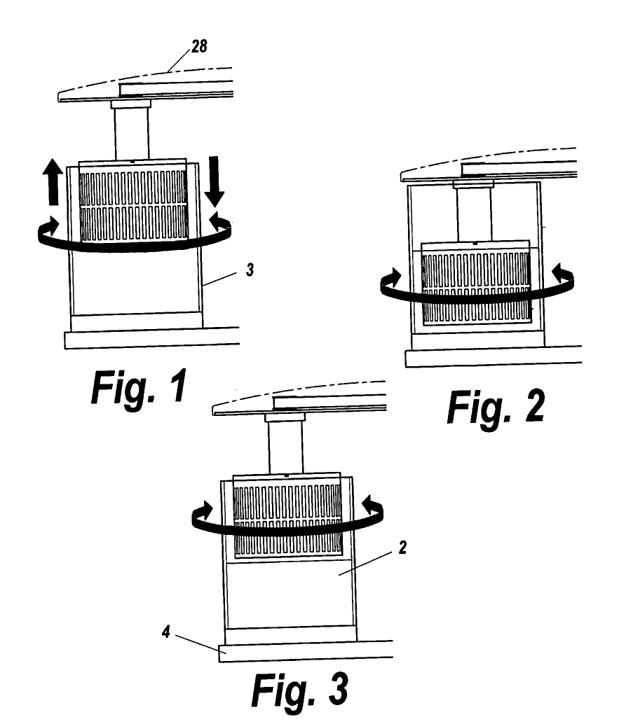

FIG. 1 diagrammatically illustrates the stirring phase of the sample through both self-rotating and up and down movements.

FIG. 2 diagrammatically illustrates the stirring phase of the sample within the processing liquid through reciprocating self-rotating movements of the basket.

FIG. 3 diagrammatically illustrates the centrifugal phase.

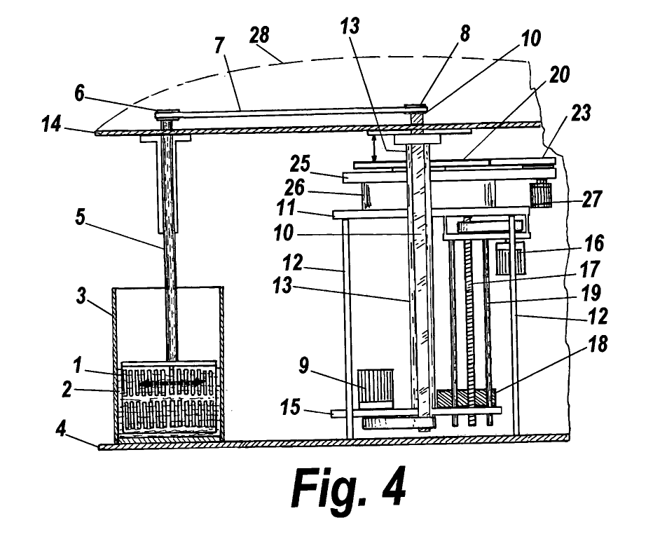

FIG. 4 is an elevated and sectional view of the machine object of the invention having the basket introduced within the beaker and inside the reactive liquid.

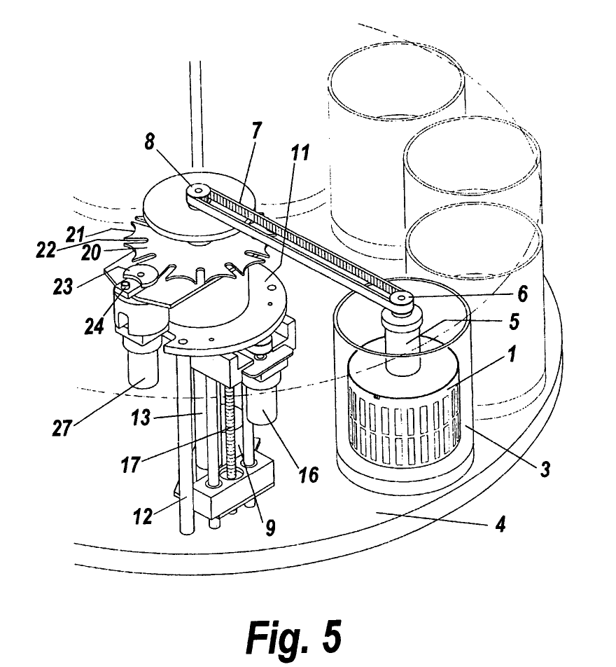

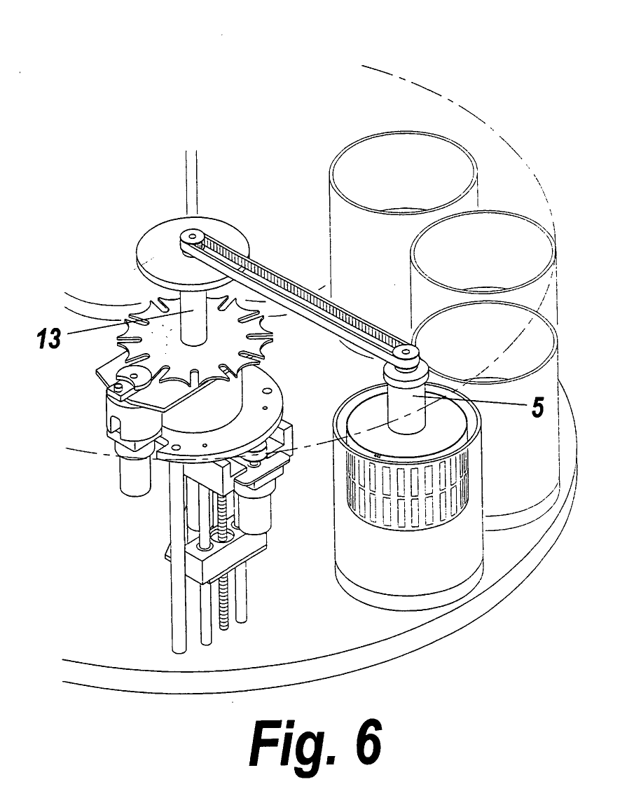

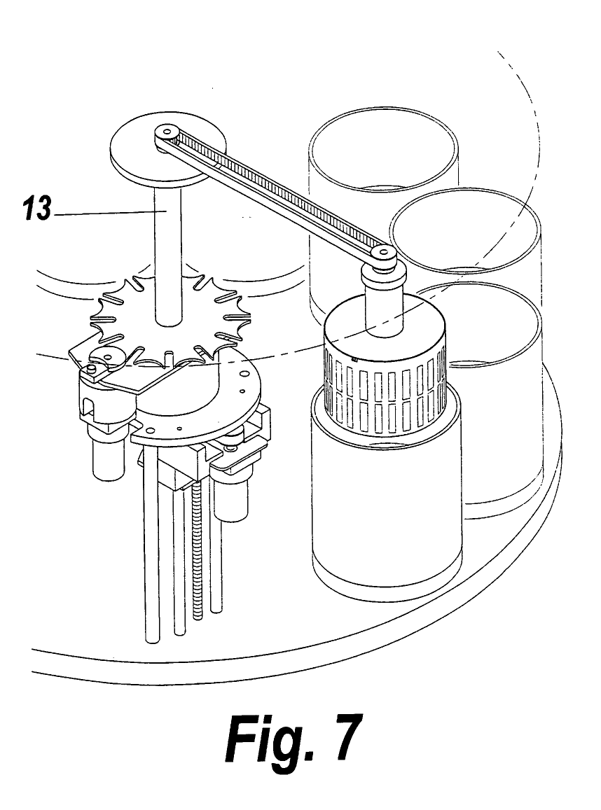

FIGS. 5, 6 and 7 are respective perspective views of the machine object of the invention in different phases of the process.

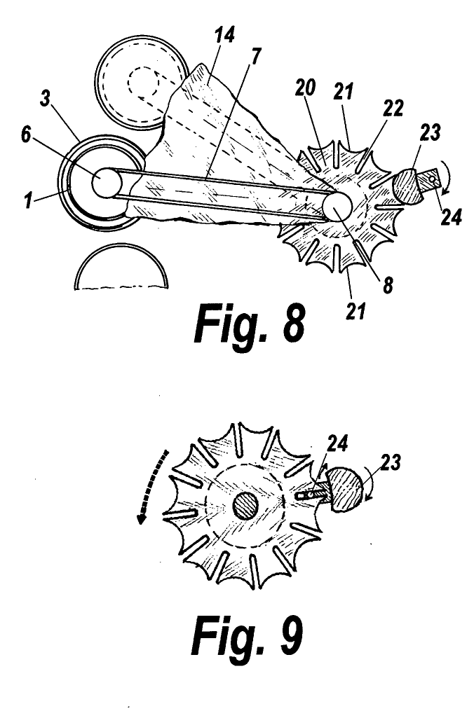

FIG. 8 is a cut partial view of the movable platform, the baskets, the Geneva cross, the coupling bolt and the disk cam during the blocking phase of the rotation of the Geneva cross.

FIG. 9 is a partial cut view of the Geneva cross assembly, the disk cam and the coupling bolt after the coupling action has taken place.

The invention comprises the preparation process of organic tissue samples made up of the already known phases of immersion of the basket (1) and the organic tissue samples contained therein into the composition consisting of processing liquid (2) contained in the corresponding beaker (3) out of the several beakers arranged in concentric relation to the turntable (4) and the vertical raising and lowering of the basket clear of the level of processing liquid for the gravity drainage and the introduction thereof within the adjoining beaker containing another processing liquid. Additional new phases are the vertical and rotary agitating action of the basket within the liquid so as to create turbulences (FIGS. 1 and 2) and hence prevent the stratification of the layers of the different components found in the liquid.

A further phase of the procedure of the invention is the centrifugation of the basket carrying the organic matter (FIG. 3) before being placed inside the beaker of the next phase containing another reactive liquid.

The new phase of vertical and rotary agitating action of the basket inside the reactive liquid takes place through the clockwise rotary self-rotating movement thereof, immediately followed by another rotary movement in the opposite direction. Thereafter the basket raising phase begins, which, at user's will, can take place without the basket stopping self-rotating, until the basket is completely or partially located clear of the level of liquid and is further immersed therein, eventually without stopping rotating, which is followed by a further movement comprising reciprocating self-rotating rotations of the basket within the liquid.

Turbulences are hence created and as a result the stratification of the liquid immersed within the beaker is prevented, which gives as a result an optimal and uniform sample processing in each workstation.

In order to obtain the reciprocating rotary movement of the movable basket (1) carrying the organic matter to be processed within the liquid mixture (2) contained in the beaker (3) from the different beakers disposed in an annular arrangement around the turntable (4), there is provided a coaxial shaft (5) that is attached to the basket, having the upper end of the said coaxial shaft (5) a pulley that is engaged to the end of a trapezial endless transmission belt (7), being the opposite end thereof also taut and connected to a further pulley (8) associated with the end of the prolongation (10) of the rotor of the step-by-step motor (9) which is provided with several speeds.

A support platform (11) supported by respective legs (12) on the base of the turntable (4) bears the coaxial shaft (13) that is coaxially inserted therein through suitable grooves. Said coaxial shaft (13) for raising and lowering the platform (14) also coaxially carries within the rotary shaft (10) which has rotary pulley (8) at the upper end thereof. The shaft (13) is supported by the platform (15) that supports the step-by-step rotary motor or main motor (9) and said platform (15) is fixed to platform (11) having free relative up and down movements relative thereto. The shaft (13) supports the platform (14) which cooperates with the up and down as well as the rotary movements of the shaft (13).

The raising and lowering of the platform (15), the shafts (13 and 10), the platform (14) and the elements connected therewith is accomplished thorough the rotation of the first additional motor (16) associated with a vertical stud (17), being this rotation imparted by means such as, respective pulleys associated with the rotor of the motor (16) and with the stud shaft (17), and joined by a trapezial endless belt. The rotation of the stud (17) raises and lowers a support-base (18), like a lineal car, associated with the support platform (15) of the motor (9) and while the raising and the lowering of the support platform (15) occurs, shafts (10 and 13) as well as platform (14) and the other associated components are also raised or lowered. By means of microswitches disposed at different heights on a support, not shown, in parallel relation to the column (19), said raising and lowering is limited to the desired height of the basket, depending on which phase is taking place, whether stirring, centrifugation or change of station.

The vertical shaft (13) coaxially carries within the shaft (10) of prolongation of the rotor of the motor (9). By means suitable grooves the shaft is capable of self-rotating relative to the other, being thus the rotation of the vertical shaft (13) independent of the shaft (10) that is located therein.

Below platform (14) and above platform (25) and through a suitable supporting structure is disposed a rotation translating motor (27) on which upper end of the rotor shaft rests the assembly comprised by a disc cam (23) and a coupling bolt (24) which rotate associated with the rotary shaft of said motor (27). In the same plane as said disk cam and coupled to the shaft (13) is a Geneva cross (20) having multiple radial arms (21) and slits (22) between the arms thereof (21). The rotation of the Geneva cross (20) is associated with the rotation of the shaft (13).

The rotation of the step-by-step motor (9) causes the rotation of the pulley (8) in a movement that is independent of the rotation of the vertical motor (13). It is said main step-by-step motor (9) which imparts, during the centrifugal phase and when the basket (1) is above the level of the liquid (2) of the beaker (3) wherein it has been immersed, rotation at a great speed to the basket, reciprocatingly and in both directions, which results in the centrifugation thereof and the organic matter contained therein.

Upon completion of the centrifugation phase the step-by-step main motor (9) stops, starting hereafter the phase of the introduction of the basket (1) in the adjoining beaker containing fresh processing liquid placed by the rotation of the motor (27) transferred to the Geneva cross mechanism (20) and by the rotary shaft (13) associated therewith, which advance the basket a distance corresponding to the new processing station of the organic tissue placed on the turntable (4).

The Geneva cross (20) in conjunction with the cam (23) enables an intermittent jogging rotary movement of the platform (14) carrying the shaft support (5) that supports and rotates the basket (1), so that the basket is transferred from one beaker to the next on the turntable (4), not within the beakers.

The cam (23) is disk-shaped so that by means of one single self-rotating rotation, it moves into and couples in the cavities of the semicircular indentations of the Geneva cross (20) radial arms (21), so that the rotary movement of the shaft (13), the platform (14) and the basket (1) ceases owing to the slowing inertia of the Geneva cross and subsequent stop thereof due to the blocking of the disk cam on the semicircular indentations of the Geneva cross (20) arms (21) (FIG. 8). This exactly coincides with the moment when the basket is within the beaker (3) and prevents the basket (1) from bumping into the beaker (3) walls. The continuation of the rotation of the additional motor (27) responsible for the rotation of disk cam (23) couples the coupling bolt (24) into the slits (22) (FIG. 9) separating the Geneva cross (21) arms (20) and causes the rotation of the Geneva cross (20), the shaft (13) and the platform, which are associated therewith, enabling the advance of the basket (1) above the beakers of the turntable (4) so that the translational movement of the basket (1) to the next station in the process can be effected.

The rotary translational motor (27) of the basket (1), the motor for the up and down movements (16), and the intermittent rotary motor (9), either clockwise or anticlockwise, are connected to the CPU of the logic card placed in a suitable location in the machine of the invention, so that the movable actuating elements are mutually time synchronized by the CPU program of the logic card, controllable by the user himself of the machine according to the organic tissue to be prepared, the amount thereof, the quality and the quantity of the reactive compositions contained in the beakers, etc.

Covering lid (28) of the machine is supported and fixed to the edge of the platform (14), cooperating with the up and down movements of the actuating shaft (13).

If necessary, several baskets (1) can simultaneously be used, with the ensuing improved performance of the machine, for instance by placing as many shafts (5) as baskets are to be simultaneously processed and increasing the range of action of the trapezial transmission belt so as to include the pulleys (6) corresponding to each shaft (5) without substantially altering the present invention.

1. Procedure for the preparation of organic or inorganic samples for the clinic or scientific examination thereof and machine for performing the said procedure, of the type comprised by a plurality of circumferentially spaced beakers (3) on turntable (4), containing the said beakers (3) a liquid composition (2) for different treatments and a basket (1) containing the samples and having the said basket (1) an up and down movement above the level of liquid (2), being said basket (1) immersed in said composition which is followed by the sample drainage phase and further being transferred to the next beaker along with the sample, characterized in that it is included in the process the agitation phase of the stratified composition of the processing liquid within the corresponding beaker (3), taking place said basket (1) agitation inside the reactive liquid (2) through a clockwise rotary self-rotating movement immediately followed by another movement in the opposite direction; starting hereafter an ascent phase of the basket, which can at user's will, be carried out without ceasing the self-rotating rotation thereof until it is completely or partially located above the level of liquid and is subsequently immersed therein, eventually without ceasing the self-rotating rotation thereof, which is followed by another movement of reciprocating basket self-rotating rotations; the gravity draining phase is replaced by a centrifugal phase and further optional translation to eventually be received in the next beaker carrying a different composition.

2. Machine for performing the procedure described in claim 1, characterized in that to the support (11) of the stud assembly (17) of the electric motor (16) that actuates the raising and lowering shaft (13) is affixed on the upper portion thereof a stationary spatial truss (26) and another platform (25) supporting the translational motor (27) on which upper end of the rotor shaft the cam assembly (23) and the coupling bolt (24) are coupled, resting said support platform (11) on the base of the turntable (4) by means of respective legs (12).

3. Machine for performing the procedure described in claim 1, according to claim 2, characterized in that the transmission of the step-by-step motor rotation (9) actuating the basket (1) is accomplished through a trapezial belt (7) associated to pulleys (6 and 8) of the upper end of the rotor (8) of said motor (9) and to the central rod (5) of said basket (1).

4. Machine for performing the procedure described in claim 1, according to claims 2 and 3, characterized in that the translational movements of the basket (1) to be received by the next beaker are accomplished through the transmission of the translational motor rotation (27) to the shaft (13) that rotates the platform (14) thanks to the coupling bolt (24) and the disk-edged cam (23) in conjunction with a Geneva cross (20) having radial arms (21) with concave ends, separated by slots (22) forming said arms, being said Geneva cross (20) located in same plane as said cam (23) and being coupled to the rotary shaft (13) and cooperating the said shaft with the rotation of the Geneva cross (20).

5. Machine for performing the procedure described in claim 1, according to claims 2 through four, characterized in that the axial shaft (5) fixed to the bottom of the basket (1) and coupled near the upper end thereof to the rotary platform (14), is provided with a suitable rolling arrangement with the said platform (14).

6. Machine for performing the procedure described in claim 1, according to claims 2 through 5, characterized in that within the translation shaft (13) and in coaxial relation therewith is the rotary shaft (10), being their respective rotations independent of each other by means of a suitable rolling arrangement.

7. Machine for performing the procedure described in claim 1, according to claims 2 through 6, characterized in that the up and down movement of the basket (1) is accomplished by means of a suitable vertical stud (17) fixed to the rotor of the motor (16), which stud through the self-rotating rotary lifting or lowering action thereof, either raises or lowers in the same direction the horizontal support base (15) placed at the lower end of the rotary shaft (10), translation shaft (13) and the associated upper platform (14).

8. Machine for performing the procedure described in claim 1, according to claims 2 through 7, characterized in that the stop, lifting and lowering height resulting from the movements of the stud (17) is obtained by means of sensors disposed, at will, along the path thereof.

9. Machine for performing the procedure described in claim 1, according to claims 2 through 8, characterized in that at the lower end of the translation shaft (13) actuated by the motor (27) thereof is inserted in and fixed to a supporting lower horizontal support means (15).

10. Machine for performing the procedure described in claim 1, according to claims 2 through 9, characterized in that the lower end of the rotary shaft (10) in coaxial relation with the translation shaft (13) is inserted through a hole in the lower horizontal support means (15) and the projecting portion thereof is coupled with the trapezial belt which imparts rotary movement to the step-by-step rotary motor (9).

11. Machine for performing the procedure described in claim 1, according to claims 2 through 10, characterized in that the stop and release of the rotary action of the motors are synchronized with each other by the program written in the CPU of the logic card situated at a suitable location in the machine formative of the machine assembly.

12. Machine for performing the procedure described in claim 1, according to claim 1, according to claims 2 through 11, characterized in that the covering lid (28) is fixed to the upper platform (14) participating in the movements of said platform (14).

13. Machine for performing the procedure described in claim 1, according to claims 2 through 12, characterized in that when necessary more that one basket (1) may be used, each one having the shaft (5) thereof inserted in the platform (14) and the respective pulleys (6) thereof linked by the trapezial belt (7) to pulley (8).
